(19) United States
(12) Patent Application Publication
(10) Pub. No.: US 2022/0374219 A1
(43) Pub. Date: Nov. 24, 2022

(54) DEPLOYMENT OF SERVICE

(71) Applicant: BEIJING BAIDU NETCOM SCIENCE TECHNOLOGY CO., LTD., BEIJING (CN)

(72) Inventor: Yiming WEN, BEIJING (CN)

(21) Appl. No.: 17/881,936

(22) Filed: Aug. 5, 2022

(30) Foreign Application Priority Data
Sep. 29, 2021 (CN) 202111151978.4

(51) Int. Cl. G06F 8/61; G06F 9/50; G06F 9/445

(52) U.S. Cl. CPC G06F 8/63; G06F 9/5027; G06F 9/4451

(57) ABSTRACT

A method is provided that includes: identifying a plurality of processing modules configured to provide a service, dependency information among the plurality of processing modules, and a plurality of performance parameters corresponding to the plurality of processing modules, respectively, wherein the plurality of processing modules are implemented as computer program instructions stored in one or more computer-readable storage mediums and are configured to be executed by one or more processors; determining thread configuration information based on the plurality of performance parameters, wherein the thread configuration information includes a plurality of thread numbers corresponding to the plurality of processing modules, respectively, wherein each thread number of the plurality of thread numbers is a number of threads included in a thread pool configured to execute the corresponding processing module; and packaging the plurality of processing modules, the dependency information, and the thread configuration information to generate an image for providing the service.

### CROSS-REFERENCE TO RELATED APPLICATIONS

This application claims priority to Chinese patent application No. 202111151978.4, filed on Sep. 29, 2021, the contents of which are hereby incorporated by reference in their entirety for all purposes.

### TECHNICAL FIELD

The present disclosure relates to the technical field of artificial intelligence, in particular to computer vision and deep learning technologies, is applicable to image processing scenes, and particularly relates to a service deployment method and apparatus, an electronic device, a computer-readable storage medium, and a computer program product.

### BACKGROUND

A web service (hereinafter referred to as “service”) is software that runs on a server and is used to provide specific functions. Some complex services are able to provide multiple functions, each of which is implemented by a code module. For example, a video surveillance service in an intelligent traffic scene may include a plurality of code modules configured to provide various functions such as vehicle type recognition, license plate number recognition, vehicle speed detection, and driver posture recognition.

Methods described in this section are not necessarily methods that have been previously conceived or employed. Unless otherwise indicated, it should not be assumed that any of the methods described in this section qualify as prior art merely by virtue of their inclusion in this section. Similarly, unless otherwise indicated, problems raised in this section should not be considered to be recognized in any prior art.

### SUMMARY

According to one aspect of the present disclosure, a method is provided, including: identifying a plurality of processing modules configured to provide a service, dependency information among the plurality of processing modules, and a plurality of performance parameters corresponding to the plurality of processing modules, respectively, wherein the plurality of processing modules are implemented as computer program instructions stored in one or more computer-readable storage mediums and are configured to be executed by one or more processors; determining thread configuration information based on the plurality of performance parameters, wherein the thread configuration information includes a plurality of thread numbers corresponding to the plurality of processing modules, respectively, wherein each thread number of the plurality of thread numbers is a number of threads included in a thread pool configured to execute the corresponding processing module; and packaging the plurality of processing modules, the dependency information, and the thread configuration information to generate an image for providing the service.

According to one aspect of the present disclosure, an electronic device is provided, including: a processor; and a memory communicatively connected to the processor, wherein the memory stores computer instructions executable by the processor, wherein the computer instructions, when executed by the processor, are configured to cause the processor to perform operations comprising: identifying a plurality of processing modules configured to provide a service, dependency information among the plurality of processing modules, and a plurality of performance parameters corresponding to the plurality of processing modules, respectively, wherein the plurality of processing modules are implemented as software to be executed by one or more processors; determining thread configuration information based on the plurality of performance parameters, wherein the thread configuration information comprises a plurality of thread numbers corresponding to the plurality of processing modules, respectively, wherein each thread number of the plurality of thread numbers is a number of threads comprised in a thread pool configured to execute the corresponding processing module; and packaging the plurality of processing modules, the dependency information, and the thread configuration information to generate an image for providing the service.

According to one aspect of the present disclosure, a non-transitory computer-readable storage medium storing computer instructions is provided, wherein the computer instructions are configured to enable a computer to perform operations comprising: identifying a plurality of processing modules configured to provide a service, dependency information among the plurality of processing modules, and a plurality of performance parameters corresponding to the plurality of processing modules, respectively, wherein the plurality of processing modules are implemented as software to be executed by one or more processors; determining thread configuration information based on the plurality of performance parameters, wherein the thread configuration information comprises a plurality of thread numbers corresponding to the plurality of processing modules, respectively, wherein each thread number of the plurality of thread numbers is a number of threads comprised in a thread pool configured to execute the corresponding processing module; and packaging the plurality of processing modules, the dependency information, and the thread configuration information to generate an image for providing the service.

### BRIEF DESCRIPTION OF THE DRAWINGS

The accompanying drawings illustrate embodiments and constitute a part of a specification, and together with the written description of the specification serve to explain example implementations of the embodiments. The shown embodiments are for illustrative purposes only and do not limit the scope of the claims. Throughout the accompanying drawings, the same reference numerals refer to similar but not necessarily identical elements.

FIG. 1 illustrates a flowchart of a service deployment method according to some embodiments of the present disclosure;

FIGS. 2A-2C illustrate schematic diagrams of example directed acyclic graphs according to embodiments of the present disclosure;

FIG. 3 illustrates a flowchart of a service deployment method according to some embodiments of the present disclosure;

FIG. 4 illustrates a structural block diagram of a service deployment apparatus according to some embodiments of the present disclosure;

FIG. 5 illustrates a structural block diagram of a service deployment apparatus according to some embodiments of the present disclosure; and

FIG. 6 illustrates a structural block diagram of an example electronic device that may be configured to implement embodiments of the present disclosure.

### DETAILED DESCRIPTION

Example embodiments of the present disclosure are described below with reference to accompanying drawings, which include various details of the embodiments of the present disclosure to facilitate understanding and should be considered as example only. Accordingly, those of ordinary skill in the art should recognize that various changes and modifications of the embodiments described herein is able to be made without departing from the scope of the present disclosure. Similarly, descriptions of well-known functions and constructions are omitted from the following description for clarity and conciseness.

In the present disclosure, unless otherwise specified, the use of terms “first”, “second”, etc. for describing various elements is not intended to limit the positional relationship, timing relationship or importance relationship of these elements, and such terms are only used to distinguish one element from another. In some examples, a first element and a second element may refer to the same instance of the elements, while in some cases they may refer to different instances based on the description of the context.

The terms used in the description of the various examples in the present disclosure are for the purpose of describing particular examples only and are not intended to be limiting. Unless the context clearly dictates otherwise, if the quantity of an element is not expressly limited, the element may be one or more. Furthermore, as used in the present disclosure, the term “and/or” covers any one and all possible combinations of listed items.

A service is software that runs on a server and is used to provide specific functions. Some complex services are able to provide multiple functions, each of which is implemented by a code module. The code modules used by the service are written by a developer. After the developer has written each code module, each code module is able to be deployed to the server, that is, the service is deployed in the server. The server is able to then provide the service to a user. Hereinafter, the code module in the service for providing the specific function is recorded as a “processing module”.

In the related art, for a complex service including a plurality of processing modules, the developer usually develops, tests and packages the processing modules respectively, and then deploys the processing modules to different servers respectively. Based on an execution sequence and dependencies among the processing modules, data transmission and calls among the processing modules are implemented through a network, so that the processing modules may provide the service as a whole. In this method, the network communication efficiency and computing performance of each processing module are not coordinated, and network resources are wasted, resulting in low computing efficiency of the overall service.

For example, based on related technologies, a video surveillance service is able to be deployed for intelligent traffic scenes. For example, the video surveillance service may include three processing modules, namely, a vehicle type recognition module, a human body detection module, and a human body posture recognition module. Based on the related technologies, the three processing modules need to be developed, tested, packaged respectively, and deployed to different servers. Subsequently, the processing modules may jointly provide the video surveillance service.

Specifically, in the process of providing the video surveillance service, a camera on a road continuously collects multiple frames of images, encode the images, and upload the images to the vehicle type recognition module and the human body detection module for processing. The vehicle type recognition module decodes the images and recognizes the type of a vehicle in the images. The human body detection module decodes the images and recognizes a driver's position in the images. Then, the human body detection module encodes the images, and transmits a code of the images and the driver's position in the images to the human body posture recognition module through a network. The human body posture recognition module decodes the images and recognizes a driver's posture in the images based on the marked driver's position. It can be seen that in the video surveillance service, calls among the processing modules need to transmit data through the network, and the images need to be encoded and decoded in each call, resulting in unnecessary performance waste. In addition, the computing performance of the three processing modules may not be coordinated, resulting in lower computing efficiency of the overall service.

In view of the problems existing in the related art, the present disclosure provides a service deployment solution which may deploy a complex service including a plurality of processing modules to improve the computing efficiency of the service.

The embodiments of the present disclosure are described in detail below with reference to the accompanying drawings.

It should be noted that, in the technical solution of the present disclosure, the collection, storage, use, processing, transmission, provision, disclosure, etc. of user's personal information involved are all in compliance with relevant laws and regulations, and do not violate public order and good customs.

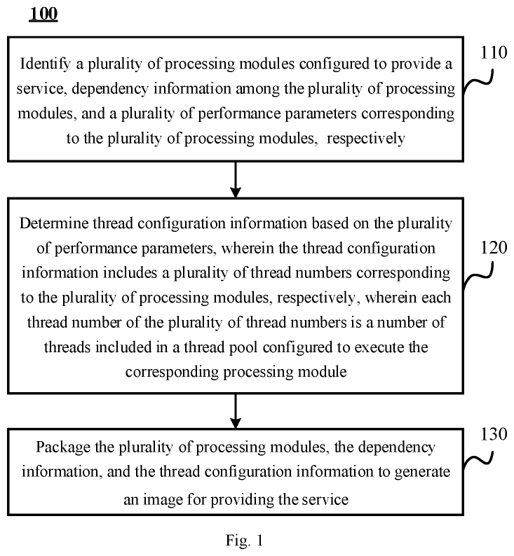

FIG. 1 shows a flowchart of a service deployment method 100 according to some embodiments of the present disclosure. The method 100 is executed in a server, that is, an execution entity of the method 100 may be the server.

As shown in FIG. 1, the method 100 includes step 110, step 120, and step 130.

At step 110, a plurality of processing modules configured to provide a service, dependency information among the plurality of processing modules, and a plurality of performance parameters corresponding to the plurality of processing modules respectively are obtained.

At step 120, thread configuration information is determined based on the plurality of performance parameters, wherein a plurality of thread numbers corresponding to the plurality of processing modules respectively, and wherein each thread number of the plurality of thread numbers is the number of threads comprised in a thread pool configured to execute the corresponding processing module.

At step 130, the plurality of processing modules, the dependency information, and the thread configuration information are packaged to generate an image for providing the service.

According to some embodiments of the present disclosure, the thread numbers of the processing modules (namely the thread configuration information) are determined based on the performance parameters of the processing modules. The processing modules, the dependency information among the processing modules, and the thread configuration information are packaged into one image for service deployment, so that the processing modules are able to be deployed in the same machine as a whole, the processing modules share memory and do not need to perform network data transmission, and the computing performance of each processing module matches, thereby improving the overall computing efficiency of the service.

At step 110, the plurality of processing modules configured to provide the service, the dependency information among the plurality of processing modules, and the plurality of performance parameters corresponding to the above plurality of processing modules are obtained.

The processing modules are code modules configured to implement specific functions. For example, a processing module may be an artificial intelligence model for image processing, audio processing, and natural language processing, or a business logic code. According to some embodiments, the processing modules may be implemented as a dynamic library, and the dynamic library includes one or more library functions.

The dependency information among the plurality of processing modules is configured to represent an execution sequence and data flow direction of the plurality of processing modules. According to some embodiments, the dependency information among the plurality of processing modules may be represented by a directed acyclic graph (DAG). A directed acyclic graph is a directed graph without loops. A directed acyclic graph is an effective tool for describing workflows. Using the directed acyclic graph to represent the dependency information among the plurality of processing modules can facilitate configuration and analysis of a dependency relationship among the processing modules. For example, the directed acyclic graph may be used to analyze whether the service composed of processing modules may be executed smoothly, to estimate the overall response time of the service, and so on.

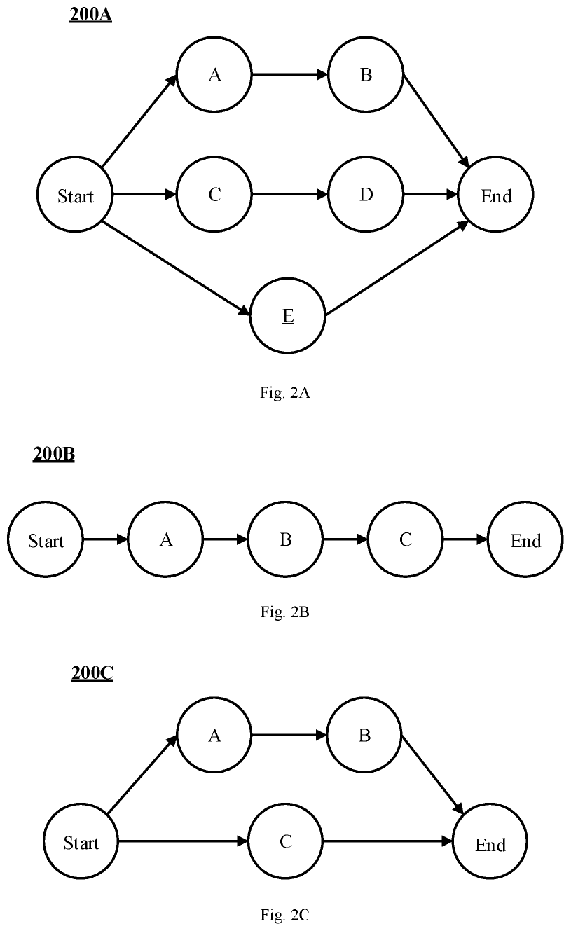

FIGS. 2A-2C show schematic diagrams of example directed acyclic graphs according to some embodiments of the present disclosure.

A directed acyclic graph 200A in FIG. 2A is configured to represent dependency information among processing modules in a service 1. As shown in FIG. 2A, the service 1 includes five processing modules, namely a processing module A to a processing module E. The five processing modules form three branches that are executed in parallel, namely, a first branch formed by the processing module A and the processing module B, a second branch formed by the processing module C and the processing module D, and a third branch formed by the processing module E separately. In each branch, the processing modules are executed serially in the direction of connecting edges. For example, in the first branch, the processing module A is executed first, and then the processing module B is executed.

A directed acyclic graph 200B in FIG. 2B is configured to represent dependency information among processing modules in a service 2. As shown in FIG. 2B, the service 2 includes three processing modules connected in series, namely, a processing module A to a processing module C. The three processing modules are executed sequentially.

A directed acyclic graph 200C in FIG. 2C is configured to represent dependency information among processing modules in a service 3. As shown in FIG. 2C, the service 3 includes three processing modules, namely a processing module A to a processing module C. The three processing modules form two branches executed in parallel, namely, a first branch formed by the processing module A and the processing module B, and a second branch formed by the processing module C separately. In the first branch, the processing module A and the processing module B are executed sequentially.

In the embodiment of the present disclosure, a performance test may be performed on each processing module in advance to obtain the performance parameter of each processing module. Correspondingly, at step 110, a plurality of performance parameters corresponding to the plurality of processing modules respectively may be obtained. Each performance parameter of the plurality of performance parameters indicates unit performance of the corresponding processing module, and the unit performance is performance of the corresponding processing module executed by a single thread. The performance parameter may be, for example, average request response time of the corresponding processing module executed by a single thread, requests per unit time (e.g. Queries Per Second, QPS) of the corresponding processing module executed by a single thread, etc., but are not limited thereto.

At step 120, the thread configuration information may be determined based on the plurality of performance parameters corresponding to the plurality of processing modules. The thread configuration information includes a plurality of thread numbers corresponding to the plurality of processing modules respectively, and each thread number of the plurality of thread numbers is the number of threads comprised in a thread pool configured to execute the corresponding processing module.

According to some embodiments, for any processing module, the thread number of the processing module is negatively correlated to the unit performance of the processing module. That is, the lower the unit performance of the processing module indicated by the performance parameter of the processing module, the greater the thread number of the processing module. Thus, the thread number of a low-performance processing module can be increased, the computing efficiency of the low-performance processing module can be improved, and the shortcomings of the service can be eliminated, thereby improving the overall computing efficiency of the service.

Further, according to some embodiments, step 120 further includes:

step 122, where a ratio of the plurality of thread numbers is determined based on the plurality of performance parameters; and

step 124, where the plurality of thread numbers are determined based on the ratio.

Based on the above embodiments, the thread number of each processing module can be determined according to a performance ratio of each processing module, so that the computing performance of each processing module matches with each other to achieve an effect of performance alignment, thereby improving the overall computing efficiency of the service.

According to some embodiments, for step 122, in the case where the performance parameter is the average request response time of the corresponding processing module executed by a single thread, the ratio of the thread numbers of any two processing modules in the plurality of processing modules is directly proportional to a ratio of the average request response time of the two processing modules. In these embodiments, the smaller the average request response time of a processing module, the higher the computing performance of the processing module, and the less the thread number needed. That is, the thread numbers of the processing modules are consistent with the variation trend of their average request response time. For example, if a ratio of the average request response time of two processing modules is 1:2, the ratio of the thread numbers of the two processing modules may be 1:2. For another example, if a ratio of the average request response time of three processing modules is 2:1:4, a ratio of the thread numbers of the three processing modules may be 2:1:4.

According to some embodiments, for step 122, in the case where the performance parameter is the requests per unit time of the corresponding processing module executed by a single thread, the ratio of the thread numbers of any two processing modules in the plurality of processing modules is inversely proportional to a ratio of the requests per unit time of the two processing modules. In these embodiments, the smaller the requests per unit time of a processing module is, the lower the computing performance of the processing module is, and the more threads are needed. That is, the thread numbers of the processing modules are opposite to the variation trend of their requests per unit time. For example, if a ratio of the requests per unit time of two processing modules is 1:2, a ratio of the thread numbers of the two processing modules may be 2:1. For another example, if a ratio of the requests per unit time of three processing modules is 2:1:4, a ratio of the thread numbers of the three processing modules may be 2:4:1.

After the ratio of the thread numbers of the plurality of processing modules is determined according to step 122 above, step 124 may be executed to determine, based on the ratio, the respective thread number of each processing module.

According to some embodiments, the ratio of the plurality of thread numbers obtained through step 122 is a minimum integer ratio. Correspondingly, at step 124, the minimum integer ratio may be magnified by N times (N is a positive integer) to obtain the thread number of each processing module. For example, the minimum integer ratio of the thread numbers of three processing modules obtained at step 122 is 2:1:2, and then at step 124, the thread numbers of the three processing modules may be set to 2, 1, and 2 respectively, or set to 4, 2, 4 respectively, or set to 6, 3, 6 respectively, and so on.

According to some embodiments, at step 124, the thread number of each processing module may be determined based on the ratio of the thread numbers of the processing modules obtained at step 122 and a plurality of unit resource utilization rates corresponding to the plurality of processing modules, so as to make the single-computer computing efficiency of the service to be maximized. Each unit resource utilization rate is resource utilization rate of the corresponding processing module executed by a single thread, and the resource utilization rate may be, for example, a CPU utilization rate, a GPU utilization rate, and so on.

According to some embodiments, step 124 may further include: determine a plurality of minimum thread numbers corresponding to the plurality of processing modules respectively based on the ratio; compute a total resource utilization rate of the plurality of processing modules based on the plurality of minimum thread numbers and the plurality of unit resource utilization rates; and determine a product of each minimum thread number and a magnification factor as the thread number of the corresponding processing module, where the magnification factor is an integer part of a quotient of a resource utilization rate threshold and the total resource utilization rate.

For example, through step 122, it is determined that a ratio of thread numbers of three processing modules is 2:1:2, so the minimum thread numbers of the three processing modules are 2, 1, and 2, respectively. Unit CPU utilization rates of the three processing modules are 3%, 6%, and 5%, respectively, so a total resource utilization rate of the three processing modules is 2×3%+1×6%+2×5%=22%. The resource utilization rate threshold may be, for example, 70%, 70%±22%=3.1818, and the integer part of the quotient is 3, that is, the magnification factor is 3. Therefore, the product of the minimum thread number of each processing module and 3 is taken as the thread number of the processing module, that is, the thread numbers of the three processing modules are 6, 3, and 6, respectively.

Step 130 is executed after the thread configuration information (namely the plurality of thread numbers corresponding to the plurality of processing modules respectively) is determined through step 120.

At step 130, the plurality of processing modules, the dependency information among the plurality of processing modules, and the thread configuration information are packaged to generate the image for providing the service.

According to some embodiments, the method 100 further includes:

step 140, where a container is started based on the image. The container includes a plurality of thread pools corresponding to the plurality of processing modules respectively.

By starting the container, the image may be instantiated to respond to user's request online and provide the service to the user. It should be understood that a container is equivalent to a process, the process includes a plurality of thread pools, and each thread pool corresponds to a processing module and is configured to execute the corresponding processing module.

According to some embodiments, step 140 further includes: the number of containers is determined based on the number of concurrent requests for the service; and the containers are started based on the image. Therefore, the number of the containers may be determined based on the concurrency of business requirements, so as to achieve elastic expansion and contraction of a service.

The number of the containers may be, for example, a roundup result of a quotient of the number of concurrent requests for the service and a maximum value of the plurality of thread numbers, namely, the number of the containers=ceil (the number of concurrent requests for the service÷the maximum value of the plurality of thread numbers), where ceil ( ) is a roundup function. The maximum value of the plurality of thread numbers may represent the number of requests that a single container may process at the same time.

For example, a video surveillance service in an intelligent traffic scene includes three processing modules: a vehicle type recognition module, a human body detection module, and a human body posture recognition module. Through step 120, it is determined that the thread numbers of the three processing modules is 6, 3, and 6, respectively, so the maximum value of the thread numbers of the processing modules is 6, that is, a single container may process 6 channels of video data at the same time. The video surveillance service needs to process the video data collected by 100 cameras at the same time, that is, the number of concurrent requests for the service is 100. Correspondingly, the number of the containers may be set as ceil(100/6)=17, that is, 17 containers need to be started.

It should be noted that when the plurality of containers are started at step 140, the plurality of containers may be located in different servers (physical machines), or may be located in the same server. It can be understood that by disposing the plurality of containers in different servers, the robustness and computing efficiency of the service may be improved.

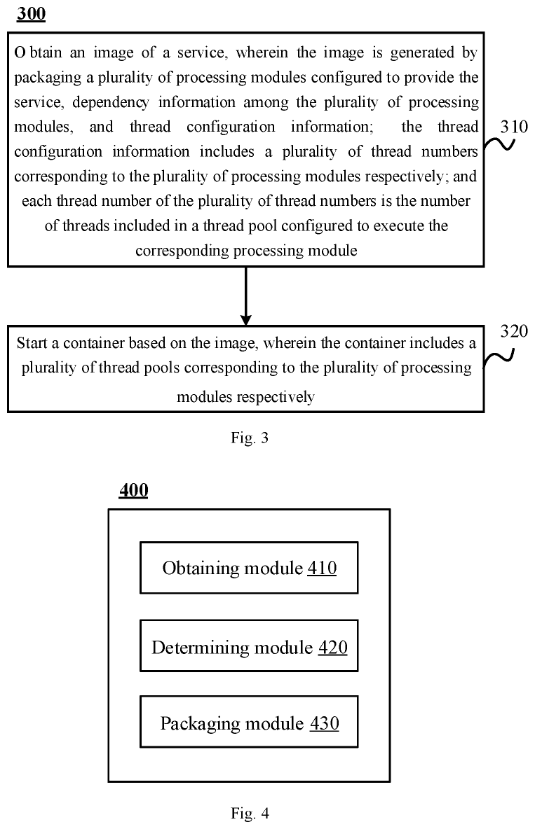

According to some embodiments of the present disclosure, another service deployment method is further provided. FIG. 3 shows a flowchart of a service deployment method 300 according to some embodiments of the present disclosure. The method 300 is executed in a server, that is, an execution entity of the method 300 may be the server.

As shown in FIG. 3, the method 300 includes step 310 and step 320.

At step 310, an image of a service is obtained, wherein the image is generated by packaging a plurality of processing modules configured to provide the service, dependency information among the plurality of processing modules, and thread configuration information; the thread configuration information comprises a plurality of thread numbers corresponding to the plurality of processing modules respectively; and each thread number of the plurality of thread numbers is the number of threads comprised in a thread pool configured to execute the corresponding processing module.

At step 320, a container is started based on the above image, wherein the container comprises a plurality of thread pools corresponding to the plurality of processing modules respectively.

According to the embodiments of the present disclosure, by starting the container, the image may be instantiated to respond to a user's request online and provide the service to the user. In addition, the plurality of processing modules included in the service may be deployed in the same machine as a whole, the processing modules share a memory and do not need to perform network data transmission, and the computing performance of each processing module matches, thereby improving the overall computing efficiency of the service.

According to some embodiments, step 320 includes: the number of containers is determined based on the number of concurrent requests for the service; and the containers are started based on the image. Therefore, the number of the containers may be determined based on the concurrency of business requirements, so as to achieve elastic expansion and contraction of a service.

For the specific implementation of step 320, reference may be made to the relevant description of step 140 above, which will not be repeated here.

According to some embodiments of the present disclosure, a service deployment apparatus is further provided. FIG. 4 shows a structural block diagram of a service deployment apparatus 400 according to some embodiments of the present disclosure. As shown in FIG. 4, the apparatus 400 includes an obtaining module 410, a determining module 420, and a packaging module 430.

In one embodiment, the obtaining module 410 is configured to obtain a plurality of processing modules configured to provide a service, dependency information among the plurality of processing modules, and a plurality of performance parameters corresponding to the plurality of processing modules respectively.

In one embodiment, the determining module 420 is configured to determine thread configuration information based on the plurality of performance parameters, wherein the thread configuration information comprises a plurality of thread numbers corresponding to the plurality of processing modules respectively, and wherein each thread number of the plurality of thread numbers is the number of threads comprised in a thread pool configured to execute the corresponding processing module.

In one embodiment, the packaging module 430 is configured to package the plurality of processing modules, the dependency information, and the thread configuration information to generate an image for providing the service.

According to the embodiments of the present disclosure, the thread number of each processing module (that is, the thread configuration information) is determined based on the performance parameter of each processing module. The processing modules, the dependency information among the processing modules, and the thread configuration information are packaged into one image for service deployment, so that the processing modules may be deployed in the same machine as a whole, the processing modules share a memory and do not need to perform network data transmission, and the computing performance of each processing module matches, thereby improving the overall computing efficiency of the service.

According to some embodiments, each performance parameter of the plurality of performance parameters indicates unit performance of the corresponding processing module, the unit performance being performance of the corresponding processing module executed by a single thread; and for any processing module, the thread number of the processing module is negatively correlated to the unit performance of the processing module.

According to some embodiments, the determining module 420 includes: a first determining unit, configured to determine a ratio of the plurality of thread numbers based on the plurality of performance parameters; and a second determining unit, configured to determine the plurality of thread numbers based on the ratio.

According to some embodiments, the performance parameter comprises average request response time of the corresponding processing module executed by a single thread, and a ratio of thread numbers of any two processing modules in the plurality of processing modules is directly proportional to a ratio of average request response time of the two processing modules.

According to some embodiments, the performance parameter comprises requests per unit time of the corresponding processing module executed by a single thread; and a ratio of thread numbers of any two processing modules in the plurality of processing modules is inversely proportional to a ratio of requests per unit time of the two processing modules.

According to some embodiments, the obtaining module 410 is further configured to: obtain a plurality of unit resource utilization rates corresponding to the plurality of processing modules respectively, wherein each unit resource utilization rate of the plurality of unit resource utilization rates is resource utilization rate of the corresponding processing module executed by a single thread, and the second determining unit includes: a third determining unit, configured to determine a plurality of minimum thread numbers corresponding to the plurality of processing modules respectively based on the ratio; a computing unit, configured to compute a total resource utilization rate of the plurality of processing modules based on the plurality of minimum thread numbers and the plurality of unit resource utilization rates; and a fourth determining unit, configured to determine a product of each minimum thread number and a magnification factor as the thread number of the corresponding processing module, wherein the magnification factor is an integer part of a quotient of a resource utilization rate threshold and the total resource utilization rate.

According to some embodiments, the dependency information among the plurality of processing modules is represented by a directed acyclic graph.

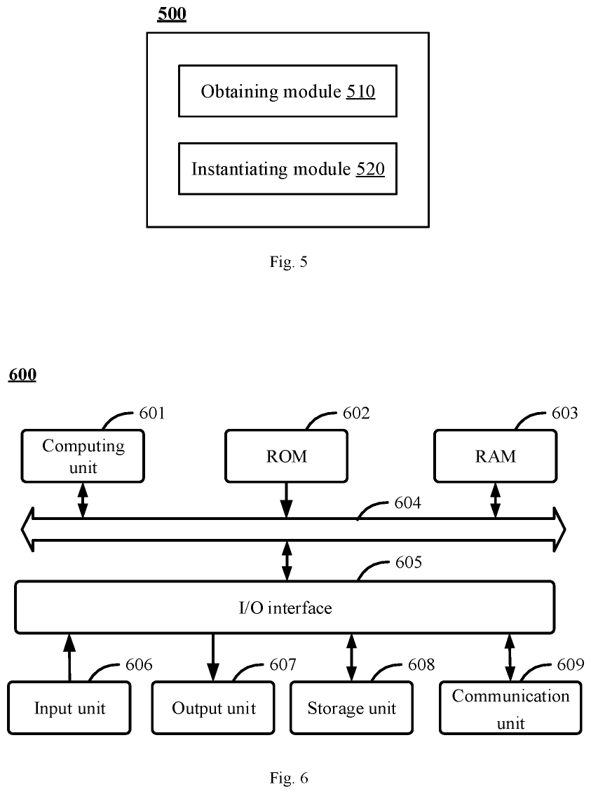

According to some embodiments of the present disclosure, a service deployment apparatus is further provided. FIG. 5 shows a structural block diagram of a service deployment apparatus 500 according to some embodiments of the present disclosure. As shown in FIG. 5, the apparatus 500 includes an obtaining module 510 and an instantiating module 520.

In one embodiment, the obtaining module 510 is configured to obtain an image of a service, wherein the image is generated by packaging a plurality of processing modules configured to provide the service, dependency information among the plurality of processing modules, and thread configuration information; the thread configuration information comprises a plurality of thread numbers corresponding to the plurality of processing modules respectively; and each thread number of the plurality of thread numbers is the number of threads comprised in a thread pool configured to execute the corresponding processing modules.

In one embodiment, the instantiating module 520 is configured to start a container based on the image, wherein the container comprises a plurality of thread pools corresponding to the plurality of processing modules respectively.

According to the embodiments of the present disclosure, by starting the container, the image may be instantiated to respond to a user's request online and provide the service to the user. In addition, the plurality of processing modules included in the service may be deployed in the same machine as a whole, the processing modules share a memory and do not need to perform network data transmission, and the computing performance of each processing module matches, thereby improving the overall computing efficiency of the service.

According to some embodiments, the instantiating module 520 includes: a concurrency determining unit, configured to determine the number of containers based on the number of concurrent requests for the service; and an instantiating unit configured to start the containers based on the image.

It should be understood that each module or unit of the apparatus 400 shown in FIG. 4 may correspond to each step in the method 100 described with reference to FIG. 1, and each module or unit of the apparatus 500 shown in FIG. 5 may correspond to each step in the method 300 described with reference to FIG. 3. Therefore, the operations, features and advantages described above for the method 100 are also applicable to the apparatus 400 and the modules and units included therein, and the operations, features and advantages described above for the method 300 are also applicable to the apparatus 500 and the modules and units included therein. For the sake of brevity, certain operations, features, and advantages are not repeated here.

Although specific functions are discussed above with reference to specific modules, it should be noted that the functions of the various modules discussed herein may be divided into a plurality of modules, and/or at least some of the functions of the plurality of modules may be combined into a single module. For example, the obtaining module 410 and the determining module 420 described above may be combined into the single module in some embodiments.

It should also be understood that various technologies may be described herein in the general context of software and hardware elements or program modules. The modules described above with respect to FIG. 4 and FIG. 5 may be implemented in hardware or in hardware in combination with software and/or firmware. For example, these modules may be implemented as computer program codes/instructions, and the computer program codes/instructions are configured to be executed in one or more processors and stored in a computer-readable storage medium. Alternatively, these modules may be implemented as hardware logic/circuitry. For example, in some embodiments, one or more of the obtaining module 410, the determining module 420, the packaging module 430, the obtaining module 510 and the instantiating module 520 may be implemented together in a System on Chip (SoC). The SoC may include an integrated circuit chip (which includes a processor (for example, a central processing unit (CPU), a microcontroller, a microprocessor, a digital signal processor (DSP), etc.), a memory, one or more communication interfaces, and/or one or more components in other circuits), and may optionally execute received program codes and/or include embedded firmware to perform functions.

According to the embodiments of the present disclosure, an electronic device, a readable storage medium, and a computer program product are further provided.

Referring to FIG. 6, a structural block diagram of an electronic device 600 that may act as a server or client of the present disclosure will be described, which is an example of a hardware device that may be applied to various aspects of the present disclosure. The electronic device is intended to represent various forms of digital electronic computer devices, such as laptop computers, desktop computers, workstations, personal digital assistants, servers, blade servers, mainframe computers, and other suitable computers. The electronic device may also represent various forms of mobile devices, such as personal digital assistants, cellular phones, smart phones, wearable devices, and other similar calculating devices. The components shown herein, their connections and relationships, and their functions are by way of example only, and are not intended to limit implementations of the present disclosure described and/or claimed herein.

As shown in FIG. 6, the device 600 includes a calculating unit 601, which may perform various appropriate actions and processes according to a computer program stored in a read only memory (ROM) 602 or a computer program loaded into a random access memory (RAM) 603 from a storage unit 608. In the RAM 603, various programs and data necessary for the operation of the device 600 may also be stored. The calculating unit 601, the ROM 602, and the RAM 603 are connected to each other through a bus 604. An input/output (I/O) interface 605 is also connected to the bus 604.

Various components in the device 600 are connected to the I/O interface 605, including: an input unit 606, an output unit 607, the storage unit 608, and a communication unit 609. The input unit 606 may be any type of device capable of inputting information to the device 600. The input unit 606 may receive input numerical or character information, and generate key signal input related to user settings and/or function control of the electronic device, and may include, but is not limited to, a mouse, a keyboard, a touch screen, a trackpad, a trackball, a joystick, a microphone and/or a remote control. The output unit 607 may be any type of device capable of presenting the information, and may include, but is not limited to, a display, speakers, video/audio output terminals, vibrators, and/or printers. The storage unit 608 may include, but is not limited to, magnetic disks and compact discs. The communication unit 609 allows the device 600 to exchange information/data with other devices through a computer network such as Internet and/or various telecommunication networks, and may include, but is not limited to, modems, network cards, infrared communication devices, wireless communication transceivers and/or chips groups, such as Bluetooth™ devices, 802.11 devices, WiFi devices, WiMax devices, cellular communication devices and/or the like.

The calculating unit 601 may be various general purpose and/or special purpose processing components with processing and calculating capabilities. Some examples of the calculating unit 601 include, but are not limited to, central processing units (CPUs), graphics processing units (GPUs), various specialized artificial intelligence (AI) calculating chips, various calculating units that run machine learning model algorithms, digital signal processors (DSPs), and any suitable processor, controller, microcontroller, etc. The calculating unit 601 executes the various methods and processes described above, such as the method 100 or the method 300. For example, in some embodiments, the method 100 or the method 300 may be implemented as computer software programs tangibly embodied on a machine-readable medium, such as the storage unit 608. In some embodiments, part or all of computer programs may be loaded and/or installed on the device 600 via the ROM 602 and/or the communication unit 609. When the computer programs are loaded to the RAM 603 and executed by the calculating unit 601, one or more steps of the method 100 or the method 300 described above may be performed. Alternatively, in other embodiments, the calculating unit 601 may be configured to execute the method 100 or the method 300 by any other suitable means (for example, by means of firmware).

Various implementations of the systems and technologies described above in this paper may be implemented in a digital electronic circuit system, an integrated circuit system, a field programmable gate array (FPGA), an application specific integrated circuit (ASIC), an application specific standard part (ASSP), a system on chip (SOC), a complex programmable logic device (CPLD), computer hardware, firmware, software and/or their combinations. These various implementations may include: being implemented in one or more computer programs, wherein the one or more computer programs may be executed and/or interpreted on a programmable system including at least one programmable processor, and the programmable processor may be a special-purpose or general-purpose programmable processor, and may receive data and instructions from a storage system, at least one input apparatus, and at least one output apparatus, and transmit the data and the instructions to the storage system, the at least one input apparatus, and the at least one output apparatus.

Program codes for implementing the methods of the present disclosure may be written in any combination of one or more programming languages. These program codes may be provided to processors or controllers of a general-purpose computer, a special-purpose computer or other programmable data processing apparatuses, so that when executed by the processors or controllers, the program codes enable the functions/operations specified in the flow diagrams and/or block diagrams to be implemented. The program codes may be executed completely on a machine, partially on the machine, partially on the machine and partially on a remote machine as a separate software package, or completely on the remote machine or server.

In the context of the present disclosure, a machine readable medium may be a tangible medium that may contain or store a program for use by or in connection with an instruction execution system, apparatus or device. The machine readable medium may be a machine readable signal medium or a machine readable storage medium. The machine readable medium may include but not limited to an electronic, magnetic, optical, electromagnetic, infrared, or semiconductor system, apparatus or device, or any suitable combination of the above contents. More specific examples of the machine readable storage medium will include electrical connections based on one or more lines, a portable computer disk, a hard disk, a random access memory (RAM), a read only memory (ROM), an erasable programmable read only memory (EPROM or flash memory), an optical fiber, a portable compact disk read only memory (CD-ROM), an optical storage device, a magnetic storage device, or any suitable combination of the above contents.

In order to provide interactions with users, the systems and techniques described herein may be implemented on a computer, and the computer has: a display apparatus for displaying information to the users (e.g., a CRT (cathode ray tube) or LCD (liquid crystal display) monitor); and a keyboard and a pointing device (e.g., a mouse or trackball), through which the users may provide input to the computer. Other types of apparatuses may further be used to provide interactions with users; for example, feedback provided to the users may be any form of sensory feedback (e.g., visual feedback, auditory feedback, or tactile feedback); an input from the users may be received in any form (including acoustic input, voice input or tactile input).

The systems and techniques described herein may be implemented in a computing system including background components (e.g., as a data server), or a computing system including middleware components (e.g., an application server) or a computing system including front-end components (e.g., a user computer with a graphical user interface or a web browser through which a user may interact with the implementations of the systems and technologies described herein), or a computing system including any combination of such background components, middleware components, or front-end components. The components of the system may be interconnected by digital data communication (e.g., a communication network) in any form or medium. Examples of the communication network include: a local area network (LAN), a wide area network (WAN) and the Internet.

A computer system may include a client and a server. The client and the server are generally remote from each other and usually interact through a communication network. The relationship of the client and the server arises by the computer programs running on corresponding computers and having a client-server relationship to each other. The server may be a cloud server, a server of a distributed system, or a server combined with blockchain.

It should be understood that steps may be reordered, added or deleted using the various forms of flow shown above. For example, the steps described in the present disclosure may be performed in parallel, sequentially or in different orders, and are not limited herein as long as desired results of a technical solution disclosed by the present disclosure may be achieved.

Although the embodiments or examples of the present disclosure have been described with reference to the accompanying drawings, it should be understood that the above methods, systems and devices are merely example embodiments or examples, and the scope of the present disclosure is not limited by these embodiments or examples, but is limited only by appended claims and their equivalents. Various elements of the embodiments or examples may be omitted or replaced by equivalents thereof. Furthermore, the steps may be performed in an order different from that described in the present disclosure. Further, the various elements of the embodiments or examples may be combined in various ways. Importantly, as technology evolves, many of the elements described herein may be replaced by the equivalents that appear later in the present disclosure.

What is claimed is:

1. A method, comprising:
identifying a plurality of processing modules configured to provide a service, dependency information among the plurality of processing modules, and a plurality of performance parameters corresponding to the plurality of processing modules, respectively, wherein the plurality of processing modules are implemented as computer program instructions stored in one or more computer-readable storage mediums and are configured to be executed by one or more processors;
determining thread configuration information based on the plurality of performance parameters, wherein the thread configuration information comprises a plurality of thread numbers corresponding to the plurality of processing modules, respectively, wherein each thread number of the plurality of thread numbers is a number of threads comprised in a thread pool configured to execute the corresponding processing module; and
packaging the plurality of processing modules, the dependency information, and the thread configuration information to generate an image for providing the service.

2. The method according to claim 1, wherein:
each performance parameter of the plurality of performance parameters indicates unit performance of the corresponding processing module, the unit performance being performance of the corresponding processing module executed by a single thread; and
for any given processing module of the plurality of processing modules, the thread number of the given processing module is negatively correlated to the unit performance of the given processing module.

3. The method according to claim 2, wherein the determining the thread configuration information comprises:
determining a ratio of the plurality of thread numbers based on the plurality of performance parameters; and
determining the plurality of thread numbers based on the ratio.

4. The method according to claim 3,
wherein a given performance parameter of the plurality of performance parameters comprises average request response time of the corresponding processing module executed by a single thread; and
wherein a ratio of thread numbers of any two processing modules in the plurality of processing modules is directly proportional to a ratio of average request response time of the two processing modules.

5. The method according to claim 3,
wherein a given performance parameter of the plurality of performance parameters comprises requests per unit time of the corresponding processing module executed by a single thread; and
wherein a ratio of thread numbers of any two processing modules in the plurality of processing modules is inversely proportional to a ratio of requests per unit time of the two processing modules.

6. The method according to claim 3, further comprising:
obtaining a plurality of unit resource utilization rates corresponding to the plurality of processing modules, respectively, wherein each unit resource utilization rate of the plurality of unit resource utilization rates is resource utilization rate of the corresponding processing module executed by a single thread; and
wherein the determining the plurality of thread numbers comprises:
determining, based on the ratio, a plurality of minimum thread numbers corresponding to the plurality of processing modules, respectively;
computing a total resource utilization rate of the plurality of processing modules based on the plurality of minimum thread numbers and the plurality of unit resource utilization rates; and
determining a product of each minimum thread number and a magnification factor as the thread number of the corresponding processing module, wherein the magnification factor is an integer part of a quotient of a resource utilization rate threshold and the total resource utilization rate.

7. The method according to claim 1, wherein the dependency information among the plurality of processing modules is represented by a directed acyclic graph.

8. The method according to claim 1, further comprising:
starting a container based on the image, wherein the container comprises a plurality of thread pools corresponding to the plurality of processing modules, respectively.

9. The method according to claim 8, wherein the starting the container comprises:
determining a number of containers based on a number of concurrent requests for the service; and
starting the containers based on the image.

10. An electronic device, comprising:
a processor; and
a memory communicatively connected to the processor, wherein the memory stores computer instructions executable by the processor, wherein the computer instructions, when executed by the processor, are configured to cause the processor to perform operations comprising:
identifying a plurality of processing modules configured to provide a service, dependency information among the plurality of processing modules, and a plurality of performance parameters corresponding to the plurality of processing modules, respectively, wherein the plurality of processing modules are implemented as software to be executed by one or more processors;
determining thread configuration information based on the plurality of performance parameters, wherein the thread configuration information comprises a plurality of thread numbers corresponding to the plurality of processing modules, respectively, wherein each thread number of the plurality of thread numbers is a number of threads comprised in a thread pool configured to execute the corresponding processing module; and
packaging the plurality of processing modules, the dependency information, and the thread configuration information to generate an image for providing the service.

11. The electronic device according to claim 10, wherein:
each performance parameter of the plurality of performance parameters indicates unit performance of the corresponding processing module, the unit performance being performance of the corresponding processing module executed by a single thread; and
for any given processing module of the plurality of processing modules, the thread number of the given processing module is negatively correlated to the unit performance of the given processing module.

12. The electronic device according to claim 11, wherein the determining the thread configuration information comprises:
determining a ratio of the plurality of thread numbers based on the plurality of performance parameters; and
determining the plurality of thread numbers based on the ratio.

13. The electronic device according to claim 12,
wherein a given performance parameter of the plurality of performance parameters comprises average request response time of the corresponding processing module executed by a single thread; and
wherein a ratio of thread numbers of any two processing modules in the plurality of processing modules is directly proportional to a ratio of average request response time of the two processing modules.

14. The electronic device according to claim 12,
wherein a given performance parameter of the plurality of performance parameters comprises requests per unit time of the corresponding processing module executed by a single thread; and
wherein a ratio of thread numbers of any two processing modules in the plurality of processing modules is inversely proportional to a ratio of requests per unit time of the two processing modules.

15. The electronic device according to claim 12, wherein the operations further comprise:
obtaining a plurality of unit resource utilization rates corresponding to the plurality of processing modules, respectively, wherein each unit resource utilization rate of the plurality of unit resource utilization rates is resource utilization rate of the corresponding processing module executed by a single thread; and
wherein the determining the plurality of thread numbers comprises:
determining, based on the ratio, a plurality of minimum thread numbers corresponding to the plurality of processing modules, respectively;
computing a total resource utilization rate of the plurality of processing modules based on the plurality of minimum thread numbers and the plurality of unit resource utilization rates; and
determining a product of each minimum thread number and a magnification factor as the thread number of the corresponding processing module, wherein the magnification factor is an integer part of a quotient of a resource utilization rate threshold and the total resource utilization rate.

16. The electronic device according to claim 10, wherein the dependency information among the plurality of processing modules is represented by a directed acyclic graph.

17. The electronic device according to claim 10, wherein the operations further comprise:
starting a container based on the image, wherein the container comprises a plurality of thread pools corresponding to the plurality of processing modules, respectively.

18. The electronic device according to claim 17, wherein the starting the container comprises:
determining a number of containers based on a number of concurrent requests for the service; and
starting the containers based on the image.

19. A non-transitory computer-readable storage medium storing computer instructions, wherein the computer instructions are configured to enable a computer to perform operations comprising:
identifying a plurality of processing modules configured to provide a service, dependency information among the plurality of processing modules, and a plurality of performance parameters corresponding to the plurality of processing modules, respectively, wherein the plurality of processing modules are implemented as software to be executed by one or more processors;
determining thread configuration information based on the plurality of performance parameters, wherein the thread configuration information comprises a plurality of thread numbers corresponding to the plurality of processing modules, respectively, wherein each thread number of the plurality of thread numbers is a number of threads comprised in a thread pool configured to execute the corresponding processing module; and
packaging the plurality of processing modules, the dependency information, and the thread configuration information to generate an image for providing the service.

20. The computer-readable storage medium according to claim 19, wherein:
each performance parameter of the plurality of performance parameters indicates unit performance of the corresponding processing module, the unit performance being performance of the corresponding processing module executed by a single thread; and
for any given processing module of the plurality of processing modules, the thread number of the given processing module is negatively correlated to the unit performance of the given processing module.
